(19) United States
(12) Patent Application Publication
(10) Pub. No.: US 2015/0063873 A1
(43) Pub. Date: Mar. 5, 2015

(54) IMAGE FORMING APPARATUS AND TONER CARTRIDGE

(71) Applicant: Sharp Kabushiki Kaisha, Osaka (JP)

(72) Inventors: Hiroshi TANISAWA, Osaka (JP); Hiroshi SUGIMURA, Osaka (JP)

(21) Appl. No.: 14/296,671

(22) Filed: Jun. 5, 2014

(30) Foreign Application Priority Data
Aug. 28, 2013 (JP) 2013-177067

(51) Int. Cl. G03G 15/08

(52) U.S. Cl. CPC G03G 15/0867
USPC 399/258; 399/262

(57) ABSTRACT

A multi-functional peripheral includes a toner cartridge and an apparatus main body having a toner cartridge attaching section to which the toner cartridge is attached. The toner cartridge has a tubular outer circumferential surface extending along an inserting direction X for insertion of the toner cartridge into a containing space in the toner cartridge attaching section 130A. The toner cartridge attaching section has a tubular inner circumferential surface which faces the tubular outer circumferential surface in an attached state of the toner cartridge. In the tubular outer circumferential surface, a guide groove is engraved that extends along an axis direction thereof and zigzags along a circumferential direction thereof. In the tubular inner circumferential surface, a protrusion is provided that fits in the guide groove 212 for insertion of the toner cartridge into the containing space.

### CROSS-REFERENCE TO RELATED APPLICATION

This application claims priority to Japanese Patent Application No. 2013-177067, which was filed on Aug. 28, 2013, the contents of which are incorporated herein by reference in its entirety.

### BACKGROUND OF THE TECHNOLOGY

1. Field of the Technology

The present technology relates to an image forming apparatus and a toner cartridge.

2. Description of the Related Art

An image forming apparatus which forms an image using electrophotography is able to form a high-quality image with a simple operation and maintenance thereof is easy, and therefore, has been used for a copier, a printer, a facsimile and the like and widely spread. A general electrophotographic image forming apparatus mainly includes an image bearing member on which an electrostatic latent image is to be formed, a developing section which visualizes the electrostatic latent image with a toner, a transfer section which transfers the developed toner image onto recording paper, and a fixing section which fixes the toner image transferred onto the recording paper.

In the image forming apparatus using the toner in this manner, it is necessary to replenish the toner when the toner contained in the apparatus is consumed to be exhausted. Since the toner is an aggregate of toner particles which are extremely fine and light-weight, when the toner is replenished to the image forming apparatus, the toner particles are likely to scatter in the air, thus the apparatus itself and surroundings of the apparatus become dirty in some cases. Accordingly, in recent years, a method of replacing an entire toner cartridge using a container-shaped toner cartridge capable of containing the toner inside thereof, that is, a method of detaching the toner cartridge running out of the toner from an image forming apparatus main body and attaching a new toner cartridge filled with a toner has become the mainstream.

Normally, there are many cases where an unused toner cartridge is packed in a box and kept in a free space of a room or a depository until it becomes necessary to replace a toner cartridge. In addition, a posture of the toner cartridge at a time of being kept is diverse. For example, it is kept in a posture similar to a posture in a state of being attached to the image forming apparatus in some cases, or it is kept in a posture different from the posture in the state of being attached to the image forming apparatus in other cases.

In any case, in the case of being kept in a state of maintaining a fixed posture over a long term, a toner contained in a casing of a toner cartridge is in a compressed state by gravity acting on the toner. In addition, a toner agglomerate of aggregated toner particles is likely to be generated depending on an environment in which the toner cartridge is kept.

Accordingly, immediately after attaching such a toner cartridge to an image forming apparatus main body, it is necessary to impart extremely large torque for a toner stirring section in order to rotationally drive the toner stirring section buried in the toner inside the toner cartridge. That is, in order to rotationally drive the toner stirring section in such a case, a load applied to a motor is to increase.

Then, when the load applied to the motor increases in this manner, there is a possibility that the motor loses synchronism or is broken. Thereupon, in order to ease a compressed state of a toner, as a precautionary statement, it is conventionally added on a packing material or an instruction book of a toner cartridge that shaking the toner cartridge before attaching to an image forming apparatus main body is necessary, and the like.

However, the actual circumstances are that, in many cases, the precautionary statement is missed in a case where replacement of the toner cartridge is needed, and therefore the toner cartridge is attached to the image forming apparatus main body as it is without being shaken.

Thereupon, in order to solve such a problem, for example, Japanese Unexamined Patent Publication JP-A 8-123166 (1996) proposes that, inside a toner cartridge in which a toner to an extent that a space is formed in an upper part when being unused is contained, a blocking releasing member which rotates integrally with a toner stirring member is provided on a position close to a downstream side in a rotating direction of the toner stirring member and the toner stirring member and the blocking releasing member are disposed together in the space in the upper part inside the toner cartridge at an initial state, and by such a configuration, even when toner blocking occurs in the toner cartridge, the toner stirring member is thrust into a toner agglomerate after the blocking releasing member releases the toner blocking at a time of starting, thus making it possible to prevent applying large load to the toner stirring member.

However, in the configuration proposed by JP-A 8-123166 (1996), the toner to the extent that the space is formed in the upper part when being unused is contained inside the toner cartridge, and the toner stirring member and the blocking releasing member are disposed together in the space of the upper part. Accordingly, in a case where the toner cartridge is kept in a posture that a rotational axis of the toner stirring member accords with a vertical direction, the toner stirring member and the blocking releasing member are buried in the toner and an effect of loosening the toner by the blocking releasing member is not able to be attained sufficiently, resulting in that the load applied to a motor increases and there is a possibility that the motor loses synchronism or is broken.

### SUMMARY OF THE TECHNOLOGY

An object of the technology is to provide an image forming apparatus capable of disintegrating a toner in a compressed state inside a toner cartridge newly attached, without particularly paying attention or carrying out a special operation when a toner cartridge is replaced with the newly attached toner cartridge, and a toner cartridge.

The technology provides an image forming apparatus, comprising:

a toner cartridge which contains a toner; and

an image forming apparatus main body which has a toner cartridge attaching section for attaching the toner cartridge thereto, the toner cartridge attaching section defining a containing space in which the toner cartridge is contained in an attached state and an insertion opening which leads to the containing space for inserting the toner cartridge into the containing space therethrough, the image forming apparatus main body forming an image in accordance with image data on a recording medium using toner supplied from the toner cartridge attached to the toner cartridge attaching section,

the toner cartridge having a tubular outer circumferential surface extending along an inserting direction for insertion of the toner cartridge into the containing space through the insertion opening,

the toner cartridge attaching section having a tubular inner circumferential surface which faces the tubular outer circumferential surface of the toner cartridge in the attached state of the toner cartridge,

in one of the tubular outer circumferential surface of the toner cartridge and the tubular inner circumferential surface of the toner cartridge attaching section, a guide groove being engraved that extends along an axis direction thereof and zigzags along a circumferential direction thereof, and

in the other of the tubular outer circumferential surface of the toner cartridge and the tubular inner circumferential surface of the toner cartridge attaching section, a protrusion being provided that fits in the guide groove for insertion of the toner cartridge into the containing space through the insertion opening.

Moreover, the technology provides an image forming apparatus, comprising:

a toner cartridge which contains a toner; and

an image forming apparatus main body which has a toner cartridge attaching section for attaching the toner cartridge thereto, the toner cartridge attaching section defining a containing space in which the toner cartridge is contained in an attached state and an insertion opening which leads to the containing space for inserting the toner cartridge into the containing space therethrough, the image forming apparatus main body forming an image in accordance with image data on a recording medium using toner supplied from the toner cartridge attached to the toner cartridge attaching section,

the toner cartridge having a tubular outer circumferential surface extending along an inserting direction for insertion of the toner cartridge into the containing space through the insertion opening,

the toner cartridge attaching section having a tubular inner circumferential surface which faces the tubular outer circumferential surface of the toner cartridge in the attached state of the toner cartridge,

in one of the tubular outer circumferential surface of the toner cartridge and the tubular inner circumferential surface of the toner cartridge attaching section, a concavo-convex section being provided in which a concave and a convex are formed continuously along an axis direction thereof, and

in the other of the tubular outer circumferential surface of the toner cartridge and the tubular inner circumferential surface of the toner cartridge attaching section, a protrusion being provided that faces the concavo-convex section for insertion of the toner cartridge into the containing space through the insertion opening.

Moreover, the technology provides a toner cartridge capable of being attached to a toner cartridge attaching section provided in an image forming apparatus main body which forms an image in accordance with image data on a recording medium using a toner, comprising:

a tubular outer circumferential surface extending along an inserting direction for insertion of the toner cartridge into a containing space formed in the toner cartridge attaching section, the tubular outer circumferential surface having a guide groove engraved therein in which a protrusion provided in an inner circumferential surface defining the containing space in the toner cartridge attaching section fits for insertion of the toner cartridge into the containing space, the guide groove extending along an axis direction thereof and zigzagging along a circumferential direction thereof.

Moreover, the technology provides a toner cartridge capable of being attached to a toner cartridge attaching section provided in an image forming apparatus main body which forms an image in accordance with image data on a recording medium using a toner, comprising:

a tubular outer circumferential surface extending along an inserting direction for insertion of the toner cartridge into a containing space formed in the toner cartridge attaching section, the tubular outer circumferential surface being provided with a protrusion which fits in a guide groove engraved in an inner circumferential surface defining the containing space in the toner cartridge attaching section for insertion of the toner cartridge into the containing space, the guide groove extending along an axis direction thereof and zigzagging along a circumferential direction thereof.

Moreover, the technology provides a toner cartridge capable of being attached to a toner cartridge attaching section provided in an image forming apparatus main body which forms an image in accordance with image data on a recording medium using a toner, comprising:

a tubular outer circumferential surface extending along an inserting direction for insertion of the toner cartridge into a containing space formed in the toner cartridge attaching section, the tubular outer circumferential surface being provided with a concavo-convex section in which a concave and a convex are formed continuously along an axis direction thereof, the concavo-convex section facing a protrusion provided in an inner circumferential surface defining the containing space in the toner cartridge attaching section for insertion of the toner cartridge into the containing space.

Moreover, the technology provides a toner cartridge capable of being attached to a toner cartridge attaching section provided in an image forming apparatus main body which forms an image in accordance with image data on a recording medium using a toner, comprising:

a tubular outer circumferential surface extending along an inserting direction for insertion of the toner cartridge into a containing space formed in the toner cartridge attaching section, the tubular outer circumferential surface being provided with a protrusion which faces a concavo-convex section provided in an inner circumferential surface defining the containing space in the toner cartridge attaching section for insertion of the toner cartridge into the containing space, the concavo-convex section having a concave and a convex formed continuously along an axis direction thereof.

According to the technology, it is possible to disintegrate a toner in a compressed state inside a toner cartridge newly attached, without particularly paying attention or carrying out a special operation when a toner cartridge is replaced with the newly attached toner cartridge.

### BRIEF DESCRIPTION OF THE DRAWINGS

Other and further objects, features, and advantages of the technology will be more explicit from the following detailed description taken with reference to the drawings wherein:

FIG. 1 is a schematic view showing an entire configuration of a multi-functional peripheral according to a first embodiment;

FIG. 2 is a perspective view showing an external appearance of the multi-functional peripheral in a state where an opening/closing door is opened for attaching or replacing a toner cartridge;

FIGS. 3A through 3D are views schematically showing a configuration of the toner cartridge;

FIG. 4 is a cross sectional view schematically showing a configuration of a toner cartridge attaching section;

FIG. 5 is a cross sectional view taken along the line V-V in FIG. 4;

FIG. 6 is a perspective view showing an external appearance of a multi-functional peripheral according to a second embodiment;

FIGS. 7A through 7D are views schematically showing a configuration of the toner cartridge;

FIGS. 8A and 8B are views schematically showing a configuration of the toner cartridge attaching section;

FIG. 9 is a cross sectional view taken along the line IX-IX in FIG. 8B;

FIG. 10 is a perspective view showing an external appearance of a multi-functional peripheral according to a third embodiment;

FIGS. 11A through 11C are views schematically showing a configuration of a toner cartridge;

FIGS. 12A and 12B are views schematically showing a configuration of a toner cartridge attaching section;

FIG. 13 is a cross sectional view taken along the line XIII-XIII in FIGS. 12A and 12B;

FIG. 14 is a perspective view showing an external appearance of a multi-functional peripheral according to a fourth embodiment;

FIGS. 15A through 15C are views schematically showing a configuration of a toner cartridge;

FIGS. 16A and 16B are views schematically showing a configuration of a toner cartridge attaching section;

FIG. 17 is a cross sectional view showing a state where the toner cartridge is attached to the toner cartridge attaching section;

FIGS. 18A through 18C are views for explaining a process that the toner cartridge is inserted into the containing space of the toner cartridge attaching section; and

FIG. 19A is a view schematically showing a configuration of a toner cartridge, and FIG. 19B is a view schematically showing a configuration of a toner cartridge attaching section.

### DETAILED DESCRIPTION

Now referring to the drawings, preferred embodiments are described below.

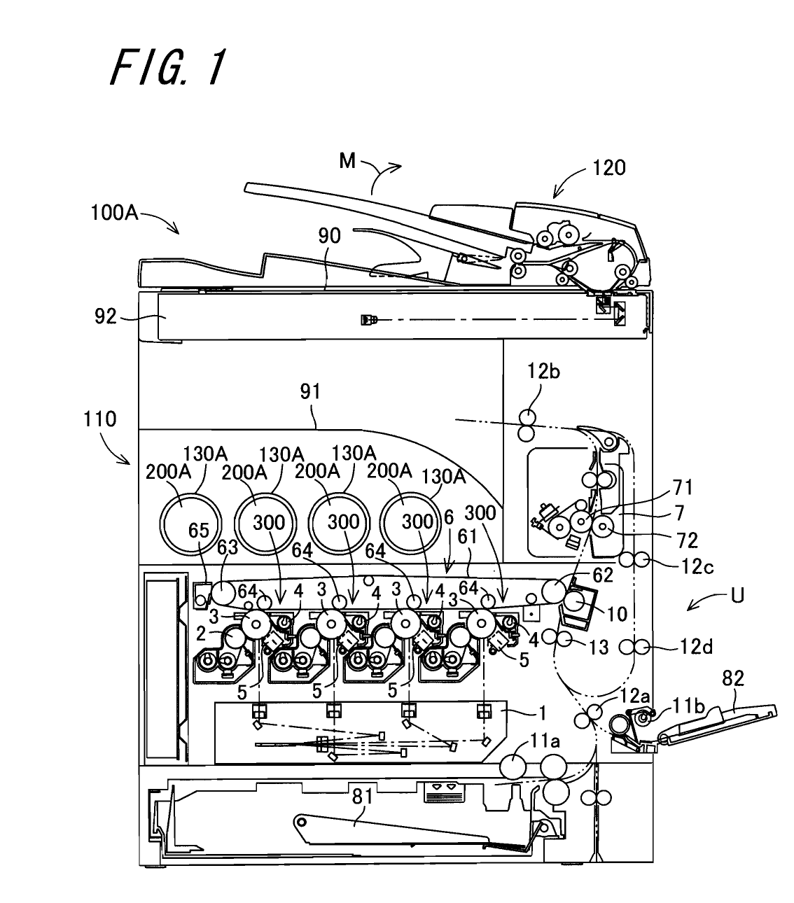

FIG. 1 is a schematic view showing an entire configuration of a multi-functional peripheral 100A according to a first embodiment. The multi-functional peripheral 100A is an apparatus which forms a multicolor or a monochromatic image on a recording medium such as a recording sheet based on image data. The multi-functional peripheral 100A includes an apparatus main body 110, an automatic document processing device 120, and a toner cartridge 200A.

The apparatus main body 110 has, at a vertically upper part thereof, a document platen 90 on which a document is placed and which is made of transparent glass and a reading section 92. The automatic document processing device 120 is mounted on a vertically upper side of the document platen 90. The automatic document processing device 120 is a device which conveys the document onto the document platen 90. The automatic document processing device 120 is configured so as to be angularly displaceable in a direction M departing from the document platen 90, and is configured so that the document is able to be manually placed on the document platen 90. Image information of the document placed on the document platen 90 is read by the reading section 92, and inputted to a not-shown control section.

The apparatus main body 110 includes an exposure unit 1, a developing device 2, a photoreceptor drum 3, a cleaner unit 4, a charging device 5, an intermediate transfer unit 6, a secondary transfer roller 10, a fixing unit 7, an inner paper feed cassette 81, a paper feed tray 82, a catch tray 91, a recording medium conveying section U, and a toner cartridge attaching section 130A to which the toner cartridge 200A is attached so as to be attachable/detachable. In this embodiment, the photoreceptor drum 3, the cleaner unit 4 and the charging device 5 are provided in a process cartridge 300 which is attachable/detachable to/from the apparatus main body 110.

Image data which is dealt with in the multi-functional peripheral 100A corresponds to a color image which uses each color of black (K), cyan (C), magenta (M), and yellow (Y). Therefore, the developing device 2, the process cartridge 300 and the toner cartridge attaching section 130A are provided by fours according to each color, and the toner cartridge 200A in which a toner of a corresponding color is contained is attached to each toner cartridge attaching section 130A.

The photoreceptor drum 3 is a cylindrical member which is supported by a not-shown driving section so as to be rotatable around an axis thereof. The photoreceptor drum 3 includes a not-shown conductive substrate and a photosensitive layer formed on a surface of the conductive substrate. The photosensitive layer is a member which shows electric conductivity by being irradiated with light. An electric image called an electrostatic latent image is formed on a surface of the photosensitive layer of the photoreceptor drum 3 by charging by the charging device 5 and exposure by the exposure unit 1.

The charging device 5 is a device which charges a surface of the photoreceptor drum 3 to a predetermined electrode and potential by a corona discharge. The charging device 5 is disposed in a vertically downward direction of the photoreceptor drum 3 and the cleaner unit 4 along a longitudinal direction of the photoreceptor drum 3 at a position facing the photoreceptor drum 3.

The exposure unit 1 is a device which irradiates the photoreceptor drum 3 with light. The exposure unit 1 forms an electrostatic latent image in accordance with image data on the surface of the photoreceptor drum 3 by exposing the charged photoreceptor drum 3 in accordance with the image data.

A laser scanning unit (LSU) is usable as the exposure unit 1. The LSU includes a laser light emitting section that emits laser light which is modulated in accordance with image data, a polygon mirror that deflects the laser light which is emitted from the laser light emitting section, a convergent lens that converges the laser light which is deflected by the polygon mirror, and a reflection mirror which reflects the laser light which is converged by the convergent lens. Note that, the exposure unit 1 is not limited to the LSU, and may be an EL (Electro Luminescence) or LED (Light Emitting Diode) writing head in which light emitting elements are arranged in an array, and the like.

The developing device 2 is a member which visualizes the electrostatic latent image formed on the photoreceptor drum 3 by the toner of each color of four colors (CMYK). The developing device 2 forms a toner image on the photoreceptor drum 3 by supplying the toner on the photoreceptor drum 3 in a state where the electrostatic latent image is formed.

The cleaner unit 4 is a member which collects the toner remaining on the surface of the photoreceptor drum 3 after transferring the toner image onto an intermediate transfer belt 61 described below.

The intermediate transfer unit 6 is disposed in a vertically upward direction of the photoreceptor drum 3 and provided with the intermediate transfer belt 61, an intermediate transfer belt driving roller 62, an intermediate transfer belt driven roller 63, a primary transfer roller 64, and an intermediate transfer belt cleaning unit 65.

The intermediate transfer belt 61 is supported around the intermediate transfer belt driving roller 62, the intermediate transfer belt driven roller 63 and the primary transfer roller 64 with tension so as to come in contact with each photoreceptor drum 3. The intermediate transfer belt 61 is formed to be endless, using a film whose thickness is approximately 100 μm to 150 μm, for example. The intermediate transfer belt driving roller 62 and the intermediate transfer belt driven roller 63 are members which cause the intermediate transfer belt 61 to rotate in a predetermined direction.

The respective toner images of the respective colors formed on the respective photoreceptor drums 3 are successively overlaid and transferred onto the intermediate transfer belt 61, and a color toner image (multicolor toner image) is formed. The toner image formed on the intermediate transfer belt 61 is conveyed to a position facing a secondary transfer roller 10 by rotation of the intermediate transfer belt 61.

Four of the primary transfer rollers 64 are provided corresponding to each color of CMYK. The primary transfer roller 64 applies transfer bias which is a voltage for transferring each toner image on each photoreceptor drum 3 onto the intermediate transfer belt 61 to the intermediate transfer belt 61. The primary transfer roller 64 is a roller-shaped member which includes a metal (for example, stainless steel) shaft having a diameter of 8 mm to 10 mm and a conductive elastic material (for example, EPDM (ethylene-propylene copolymerization rubber), urethane foam, and the like) which covers a surface of the metal shaft. The primary transfer roller 64 is able to apply the transfer bias uniformly to the intermediate transfer belt 61 by the conductive elastic material.

The secondary transfer roller 10 is a member which transfers the color toner image formed on the intermediate transfer belt 61 as described above onto a recording medium. The secondary transfer roller 10 is disposed so as to sandwich the intermediate transfer belt 61 together with the intermediate transfer belt driving roller 62. A voltage for transferring the color toner image onto the recording medium is applied to the secondary transfer roller 10. In order to form a nip by the secondary transfer roller 10 and the intermediate transfer belt driving roller 62, it is preferable that one of the secondary transfer roller 10 and the intermediate transfer belt driving roller 62 is formed of a hard material (metal or the like) and the other is formed of a soft material (elastic rubber, formed resin, or the like).

The intermediate transfer belt cleaning unit 65 is a member which collects a toner remaining on the intermediate transfer belt 61 after the color toner image is transferred onto the recording medium. The intermediate transfer belt cleaning unit 65 is provided with a cleaning blade which comes in contact with the intermediate transfer belt 61 and the cleaning blade sandwiches the intermediate transfer belt 61 together with the intermediate transfer belt driven roller 63.

The fixing unit 7 is provided with a heat roller 71 and a pressure roller 72. The heat roller 71 and the pressure roller 72 are provided so as to be rotatable with the recording medium nipped. The heat roller 71 is set to reach a predetermined temperature by the not-shown control section based on a signal from a not-shown temperature detector. By thermally bonding the toner configuring the color toner image on the recording medium, the heat roller 71 and the pressure roller 72 fuse the toner for fixing on the recording medium.

The inner paper feed cassette 81 and the paper feed tray 82 are members which stock a recording medium such as a recording sheet used for image formation. The catch tray 91 is a tray for accumulating the recording medium on which an image is formed in a face-down manner.

The recording medium conveying section U is a member which sends the recording medium from the inner paper feed cassette 81 and the paper feed tray 82 to the catch tray 91 through the secondary transfer roller 10 and the fixing unit 7. The recording medium conveying section U is provided with pickup rollers 11a and 11b, conveying rollers 12a, 12b, 12c and 12d, and a registration roller 13.

The pickup roller 11a is a member which is provided in a vicinity of an end part of the inner paper feed cassette 81 and takes out the recording medium one by one from the inner paper feed cassette 81. The pickup roller 11b is a member which is provided in a vicinity of an end part of the paper feed tray 82 and takes out the recording medium one by one from the paper feed tray 82.

The conveying rollers 12a through 12d are small-sized rollers for conveying the recording medium. The registration roller 13 is a member which keeps a conveyed sheet temporally and conveys the recording medium to the secondary transfer roller 10 at a timing when the recording medium meets the color toner image on the intermediate transfer belt 61.

In the multi-functional peripheral 100A, the recording medium taken out from the inner paper feed cassette 81 or the paper feed tray 82 is conveyed to the registration roller 13 and, by the registration roller 13, conveyed to the secondary transfer roller 10 at a predetermined timing, and, when passing between the secondary transfer roller 10 and the intermediate transfer belt 61, the toner image is transferred. The recording medium onto which the toner image is transferred passes through the fixing unit 7 to thereby cause the toner image to be fixed, and discharged on the catch tray 91 through the conveying roller 12b.

Note that, in the multi-functional peripheral 100A, in the case of duplex printing that an image is formed on both sides of a recording medium, the recording medium on which fixation of a toner image on one side is finished and which is then discharged from the fixing unit 7 is held by a back end thereof by the conveying roller 12b to be guided to the conveying rollers 12c and 12d by the conveying roller 12b. The recording medium guided to the conveying rollers 12c and 12d passes through the registration roller 13, the secondary transfer roller 10 and the fixing unit 7 again to perform printing on a back side of the recording medium and is discharged to the catch tray 91.

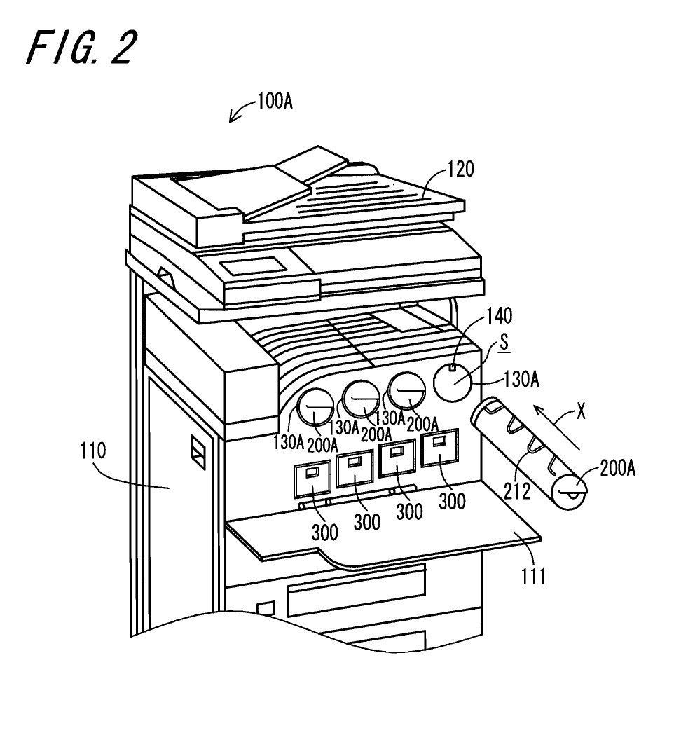

Description will be given hereinafter for a configuration of the multi-functional peripheral 100A for attaching or replacing the toner cartridge 200A. FIG. 2 is a perspective view showing an external appearance of the multi-functional peripheral 100A in a state where an opening/closing door 111 is opened for attaching or replacing the toner cartridge 200A.

As shown in FIG. 2, in the apparatus main body 110, four toner cartridge attaching sections 130A to which toner cartridges 200A of each color are attached respectively are provided, and, when the opening/closing door 111 provided on a front surface part of the apparatus main body 110 is opened, these toner cartridge attaching sections 130A are exposed to an external space.

Thereby, a user is able to detach a toner cartridge 200A running out of the toner from the toner cartridge attaching section 130A and attach a new toner cartridge 200A filled with a toner to the toner cartridge attaching section 130A. Note that, in FIG. 2, an inserting direction for insertion of the toner cartridge 200A into a containing space S described below in order to attach to the toner cartridge attaching section 130A is shown with an arrow X.

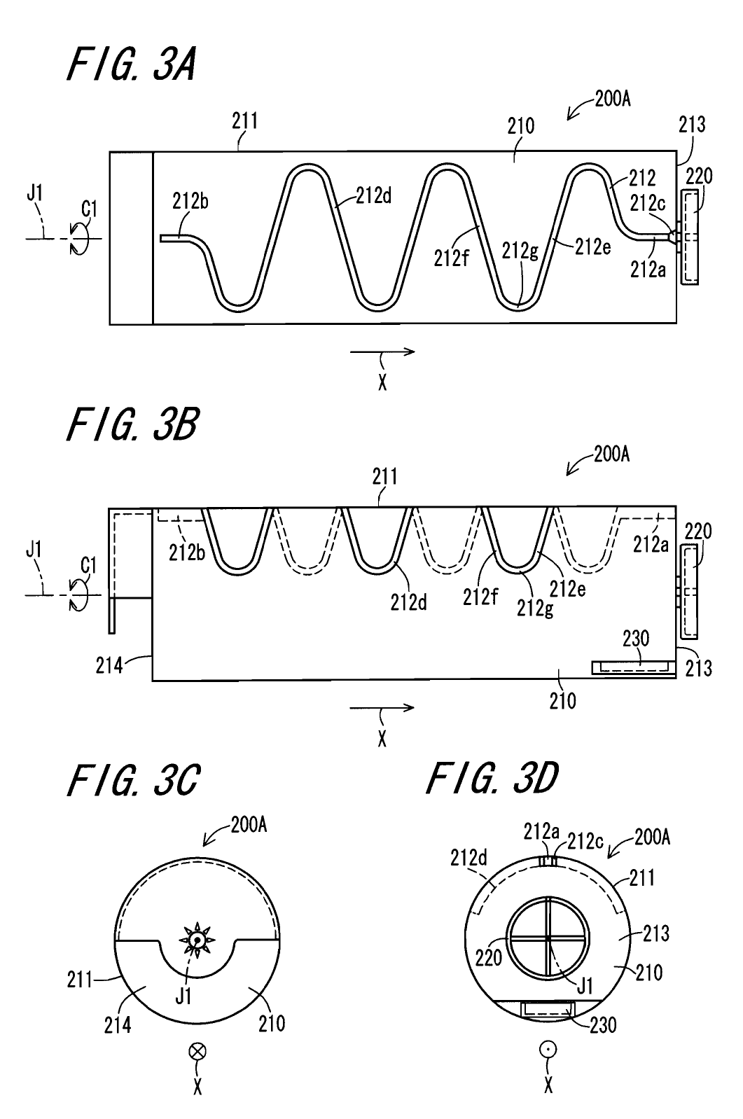

FIGS. 3A through 3D are views schematically showing a configuration of the toner cartridge 200A, and FIG. 3A is a top view of the toner cartridge 200A, FIG. 3B is a front view of the toner cartridge 200A, FIG. 3C is a left-side view of the toner cartridge 200A, and FIG. 3D is a right-side view of the toner cartridge 200A.

In this embodiment, the toner cartridge 200A is a hollow cylindrical container whose both ends are blocked, and includes a toner bottle 210 having a toner, which is a developer, contained inside and a coupling section 220 which protrudes outside from the toner bottle 210.

Here, assuming that a direction in which a central axis J1 of the toner bottle 210 extends is referred to as a “bottle axis direction”, the bottle axis direction is a direction parallel to the inserting direction X for insertion of the toner cartridge 200A into the containing space S described below.

The coupling section 220 is a portion with which, when the toner cartridge 200A is attached to the toner cartridge attaching section 130A, a driving shaft which transfers driving force of a not-shown motor provided in the apparatus main body 110 is coupled, and, in this embodiment, provided so as to protrude outside from a downstream side end part of the inserting direction X in the toner bottle 210, as shown in FIGS. 3A through 3D.

Moreover, in the toner bottle 210, a toner discharging port is formed at a portion which is in a vicinity of the downstream side end part of the inserting direction X and which is in a downward side when the toner cartridge 200A is attached to the toner cartridge attaching section 130A, and a shutter member 230 capable of opening/closing this toner discharging port is provided.

In a state where the toner cartridge 200A is not attached to the toner cartridge attaching section 130A, the shutter member 230 is disposed in a position to block the toner discharging port, and mechanically displaced to a position to open the toner discharging port as the toner cartridge 200A is attached to the toner cartridge attaching section 130A, thus making it possible to discharge a toner which is contained inside the toner bottle 210 outside from the toner discharging port. In this manner, the toner discharged outside from the toner discharging port is supplied to the developing device 2 through a not-shown supplying path.

Moreover, inside the toner bottle 210, a not-shown conveying screw which conveys the contained toner along the inserting direction X while stirring is pivotally supported in both end parts of the toner bottle 210 so as to rotate freely, and the end part of a downstream side of the inserting direction X of the conveying screw is fixed at the coupling section 220. Accordingly, when the toner cartridge 200A is attached to the toner cartridge attaching section 130A, the conveying screw is rotated around the central axis J1 by the driving force of the motor which is transferred from the driving shaft to the coupling section 220, and thereby conveys the contained toner along the inserting direction X while stirring.

In this embodiment, as shown in FIGS. 3A through 3D, a guide groove 212 which extends along the bottle axis direction and zigzags in a circumferential direction C1 around the central axis J1 is engraved in a right cylindrical outer circumferential surface 211 in the toner bottle 210 of the toner cartridge 200A.

In the right cylindrical outer circumferential surface 211, the guide groove 212 is engraved at a portion which constitutes an upper half thereof when the toner cartridge 200A is attached to the toner cartridge attaching section 130A, and linearly extends along the bottle axis direction with both end parts 212a and 212b thereof disposed in portions which constitute the most upper ends in the right cylindrical outer circumferential surface 211 when attached as described above.

The end part 212a which is disposed in the downstream side of the inserting direction X is formed so as to open in the downstream side of the inserting direction X in an end surface 213 in the downstream side of the inserting direction X in the toner bottle 210, and an opening portion 212c thereof is formed so that a groove width thereof becomes wider as heading toward the downstream side of the inserting direction X.

On the other hand, the end part 212b which is disposed in the upstream side of the inserting direction X extends so as to stop at a position which is in slightly more downstream side of the inserting direction X from an end surface 214 in the upstream side of the inserting direction X in the toner bottle 210. Note that, the guide groove 212 is formed so as to have a same groove depth through the both end parts 212a and 212b thereof and so as to have a same width in a remaining portion excluding the opening portion 212c.

A middle part 212d between the both end parts 212a and 212b of the guide groove 212 includes, when viewed from above of the toner cartridge 200A (refer to FIG. 3A), a first linear portion 212e which linearly heads to one side of the circumferential direction C1 as heading to the upstream side of the inserting direction X, a second linear portion 212f which linearly heads to the other side of the circumferential direction C1 as heading to the upstream side of the inserting direction X, and a coupling portion 212g with which the first linear portion 212e and the second linear portion 212f are coupled, and the coupling portion 212g is smoothly coupled with the first linear portion 212e and the second linear portion 212f while drawing an arc. In addition, the middle part 212d is also smoothly coupled with each end part of 212a and 212b while drawing an arc.

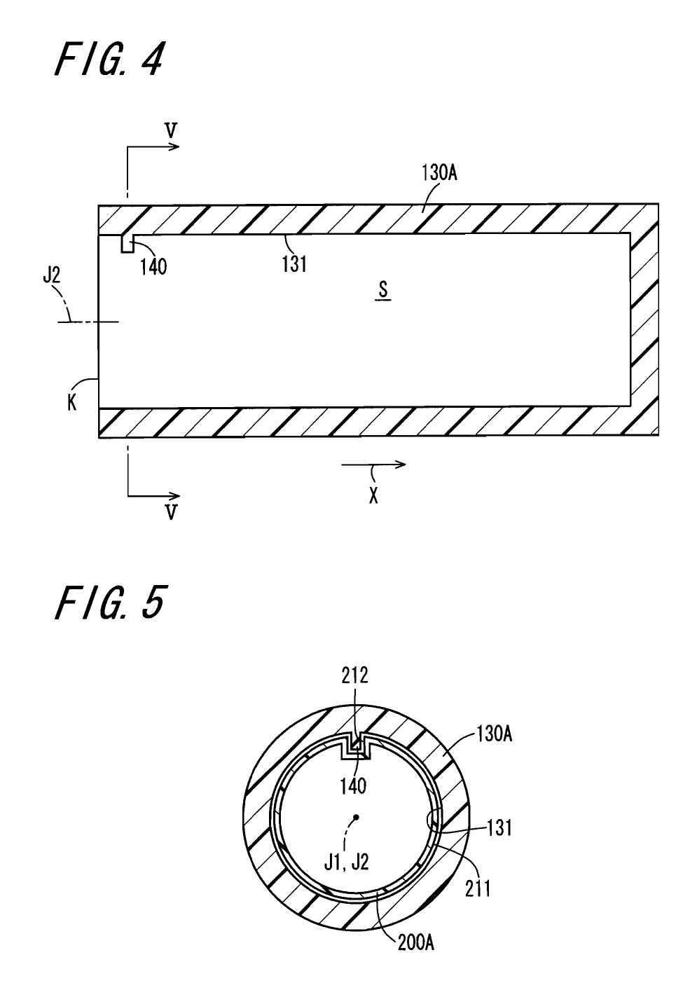

FIG. 4 is a cross sectional view schematically showing a configuration of the toner cartridge attaching section 130A and showing a cross-section when being cut along a virtual plane which includes a central axis J2 of the toner cartridge attaching section 130A and is parallel to a vertical direction.

The toner cartridge attaching section 130A is a portion to which the toner cartridge 200A is attached in the apparatus main body 110, and defines the containing space S in which the toner cartridge 200A is contained in an attached state, and an insertion opening K which leads to the containing space S for inserting the toner cartridge 200A into the containing space S. The toner cartridge attaching section 130A includes a right cylindrical inner circumferential surface 131 having an inner diameter which is slightly larger than an outer diameter of the toner bottle 210.

Here, assuming that a direction in which the central axis J2 of the inner circumferential surface 131 in the toner cartridge attaching section 130A extends is referred to as an “attaching section axis direction”, the attaching section axis direction is a direction parallel to the inserting direction X for insertion of the toner cartridge 200A into the containing space S.

In this embodiment, in the inner circumferential surface 131 in the toner cartridge attaching section 130A, a protrusion 140 which is provided so as to protrude toward inside in a radial direction at an upper end part in a vicinity of the insertion opening K.

FIG. 5 is a cross sectional view taken along the line V-V in FIG. 4, and shows the toner cartridge 200A in a process of insertion into the containing space S together. As shown in FIG. 5, the protrusion 140 is formed so as to have a size to fit in the guide groove 212 which is engraved in the outer circumferential surface 211 of the toner bottle 210 for insertion of the toner cartridge 200A into the containing space S.

In the multi-functional peripheral 100A according to this embodiment, with the configuration described above, when the toner cartridge 200A is attached to the toner cartridge attaching section 130A, the toner cartridge 200A is first inserted into the containing space S so that the protrusion 140 fits in the opening portion 212c of the guide groove 212.

While the protrusion 140 is guided by the guide groove 212, the toner cartridge 200A is then to be inserted into the containing space S as being rotated toward one side and the other side of the circumferential direction C1 around the central axis J1 thereof so as to move toward the upstream side of the inserting direction X relatively with respect to the toner cartridge 200A.

As described above, according to this embodiment, when the toner cartridge 200A is attached to the toner cartridge attaching section 130A, the toner cartridge 200A is to be inserted into the containing space S while being shaken toward one side and the other side of the circumferential direction C1.

Accordingly, even in a case where a toner is contained in a compressed state inside the toner bottle 210, by this shaking movement in the circumferential direction C1, the toner in the compressed state is disintegrated, making it possible to ease the compressed state. In this manner, in this embodiment, force applied by a user in order to insert the toner cartridge 200A into the containing space S is able to be converted to force for disintegrating the toner.

This makes it possible to prevent applying large load to the conveying screw provided inside the toner bottle 210, and thus to prevent a motor for rotationally driving the conveying screw from losing synchronism or being broken.

Moreover, according to this embodiment, every time when the toner cartridge 200A is attached to the toner cartridge attaching section 130A, the toner cartridge 200A is to be shaken toward one side and the other side of the circumferential direction C1, so that the user is able to ease the compressed state of the toner in the toner bottle 210 without particularly paying attention or carrying out a special operation.

Furthermore, according to this embodiment, the opening portion 212c in the guide groove 212 is formed so that a groove width thereof becomes wider as heading toward the downstream side of the inserting direction X, making it possible that the protrusion 140 provided in the inner circumferential surface 131 in the toner cartridge attaching section 130A easily fits to the opening portion 212c when the toner cartridge 200A is attached to the toner cartridge attaching section 130A.

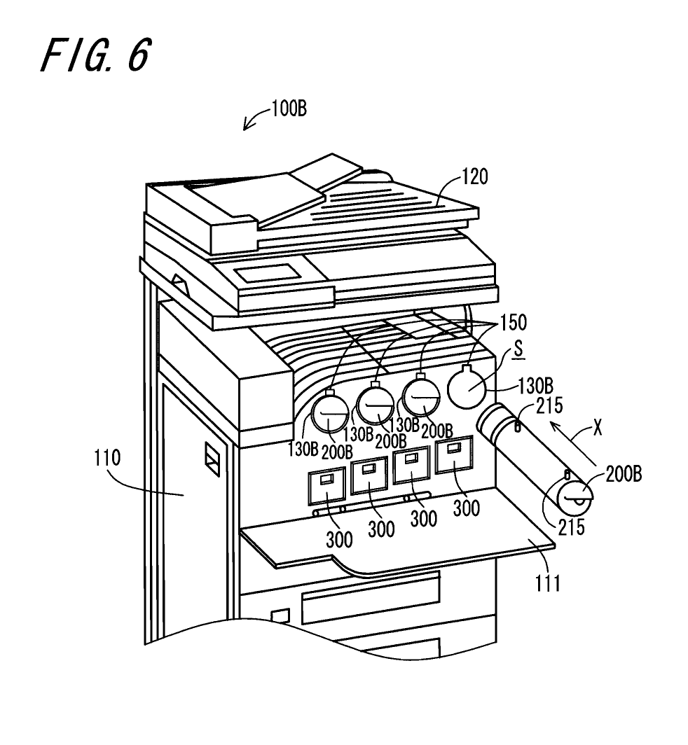

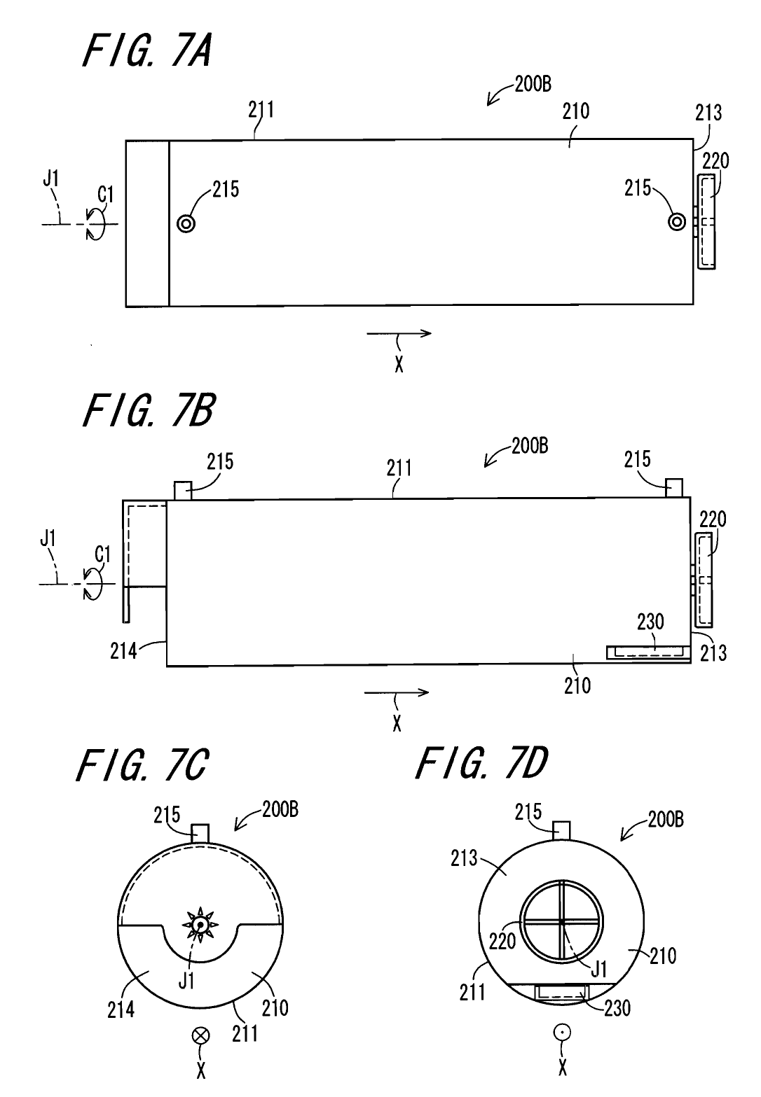

In the first embodiment described above, though the guide groove 212 is engraved in the toner cartridge 200A and the protrusion 140 which fits in the guide groove 212 is formed in the toner cartridge attaching section 130A, on the contrary, a guide groove may be engraved in a toner cartridge attaching section and a protrusion which fits to the guide groove may be provided in a toner cartridge. Hereinafter, description will be given for this embodiment using FIG. 6, FIGS. 7A through 7D, FIGS. 8A and 8B, and FIG. 9.

FIG. 6 is a perspective view showing an external appearance of a multi-functional peripheral 100B according to a second embodiment, and shows a state where an opening/closing door 111 is opened for attaching or replacing a toner cartridge 200B. As to remaining portions excluding the toner cartridge 200B and a toner cartridge attaching section 130B, the multi-functional peripheral 100B according to this embodiment is configured similarly to the multi-functional peripheral 100A according to the first embodiment, so that the same reference numerals are given for the same components and repeated description is omitted.

FIGS. 7A through 7D are views schematically showing a configuration of the toner cartridge 200B, and FIG. 7A is a top view of the toner cartridge 200B, FIG. 7B is a front view of the toner cartridge 200B, FIG. 7C is a left-side view of the toner cartridge 200B, and FIG. 7D is a right-side view of the toner cartridge 200B. Note that, in the toner cartridge 200B according to this embodiment, for portions configured similarly to the toner cartridge 200A according to the first embodiment, the same reference numerals are given and repeated description is omitted.

In the toner cartridge 200B according to this embodiment, instead of a guide groove, a protrusion 215 is provided. In detail, protrusions 215 which protrude toward outside in a radial direction are provided respectively in portions which are in vicinities of end parts of an upstream side and a downstream side of an inserting direction X and which are the most upper ends when the toner cartridge 200B is attached to the toner cartridge attaching section 130B, in the outer circumferential surface 211 of the toner bottle 210.

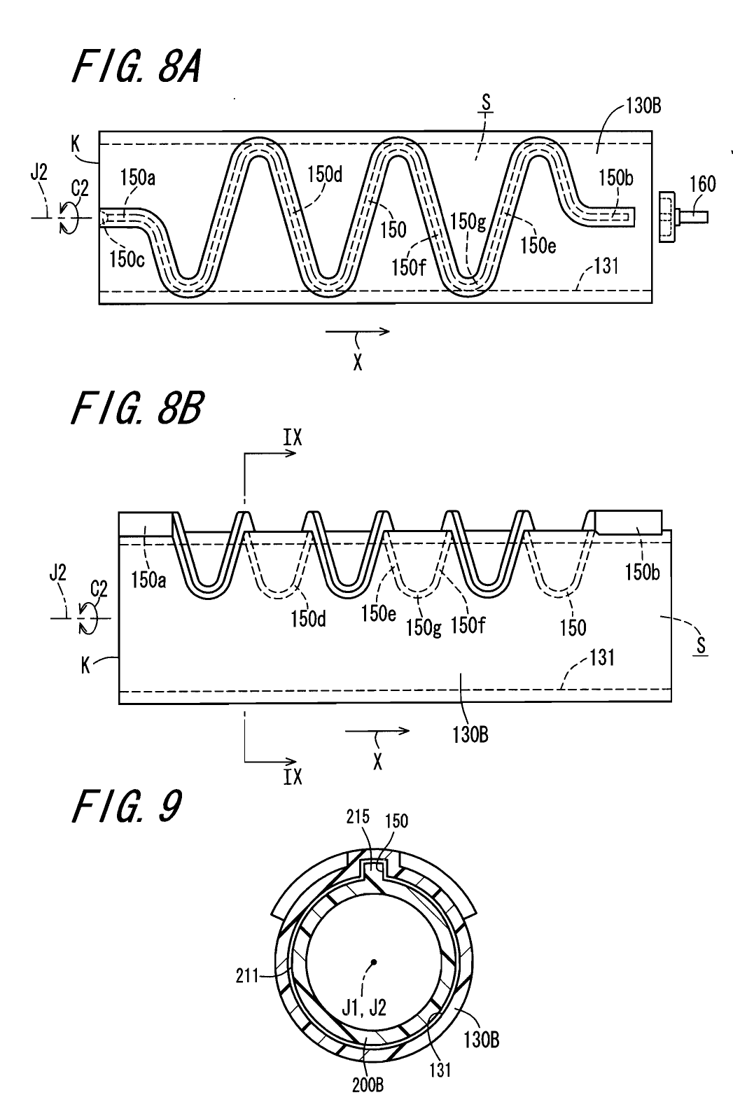

FIGS. 8A and 8B are views schematically showing a configuration of the toner cartridge attaching section 130B, and FIG. 8A is a top view of the toner cartridge attaching section 130B and FIG. 8B is a front view of the toner cartridge attaching section 130B. Note that, in the toner cartridge attaching section 130B according to this embodiment, for portions configured similarly to the toner cartridge attaching section 130A according to the first embodiment, the same reference numerals are given and repeated description is omitted. In addition, in FIG. 8A, a driving shaft 160 which is coupled with a coupling section 220 of the toner cartridge 200B when the toner cartridge 200B is attached to the toner cartridge attaching section 130B is illustrated together.

In the toner cartridge attaching section 130B according to this embodiment, instead of a protrusion, a guide groove 150 which extends along the attaching section axis direction and zigzags in a circumferential direction C2 around the central axis J2 is engraved in a right cylindrical inner circumferential surface 131.

The guide groove 150 is engraved in an area which constitutes an upper half thereof in the right cylindrical inner circumferential surface 131, and linearly extends along the attaching section axis direction with both end parts 150a and 150b thereof disposed in portions which constitute the most upper ends in the right cylindrical inner circumferential surface 131.

The end part 150a which is disposed in the upstream side of the inserting direction X is formed so as to open in the upstream side of the inserting direction X in the insertion opening K, and an opening portion 150c thereof is formed so that a groove width thereof becomes wider as heading toward the upstream side of the inserting direction X.

On the other hand, the end part 150b which is disposed in the downstream side of the inserting direction X extends so as to stop at a position which is in slightly more upstream side of the inserting direction X from an end part in the downstream side of the inserting direction X in the toner cartridge attaching section 130B. Note that, the guide groove 150 is formed so as to have a same groove depth through the both end parts 150a and 150b thereof and so as to have a same width in a remaining portion excluding the opening portion 150c.

Moreover, a middle part 150d between the both end parts 150a and 150b in the guide groove 150 includes, when viewed from above of the toner cartridge attaching section 130B (refer to FIG. 8A), a first linear portion 150e which linearly heads to one side of the circumferential direction C2 as heading to the upstream side of the inserting direction X, a second linear portion 150f which linearly heads to the other side of the circumferential direction C2 as heading to the upstream side of the inserting direction X, and a coupling portion 150g with which the first linear portion 150e and the second linear portion 150f are coupled, and the coupling portion 150g is smoothly coupled with the first linear portion 150e and the second linear portion 150f while drawing an arc. In addition, the middle part 150d is also smoothly coupled with each end part of 150a and 150b while drawing an arc.

FIG. 9 is a cross sectional view taken along the line IX-IX in FIG. 8B, and shows the toner cartridge 200B in a process of insertion into the containing space S together. As shown in FIG. 9, the protrusion 215 is formed so as to have a size to fit in the guide groove 150 which is engraved in the inner circumferential surface 131 in the toner cartridge attaching section 130B for insertion of the toner cartridge 200B into the containing space S.

In the multi-functional peripheral 100B according to this embodiment, with the configuration described above, when the toner cartridge 200B is attached to the toner cartridge attaching section 130B, the toner cartridge 200B is first inserted into the containing space S so that the protrusion 215 fits in the opening portion 150c of the guide groove 150.

The toner cartridge 200B is then to be inserted into the containing space S as being rotated toward one side and the other side of the circumferential direction C1 around the central axis J1 thereof, so that the protrusion 215 moves toward the downstream side of the inserting direction X while being guided by the guide groove 150.

As described above, according to this embodiment, when the toner cartridge 200B is attached to the toner cartridge attaching section 130B, the toner cartridge 200B is to be inserted into the containing space S while being shaken toward one side and the other side of the circumferential direction C1.

Accordingly, even in a case where a toner is contained in a compressed state inside a toner bottle 210, by this shaking movement in the circumferential direction C1, the toner in the compressed state is disintegrated, making it possible to ease the compressed state. In this manner, in this embodiment, force applied by a user in order to insert the toner cartridge 200B into the containing space S is able to be converted to force for disintegrating the toner.

This makes it possible to prevent applying large load to the conveying screw provided inside the toner bottle 210, and thus to prevent a motor for rotationally driving the conveying screw from losing synchronism or being broken.

Moreover, according to this embodiment, every time when the toner cartridge 200B is attached to the toner cartridge attaching section 130B, the toner cartridge 200B is to be shaken toward one side and the other side of the circumferential direction C1, so that the user is able to ease the compressed state of the toner in the toner bottle 210 without particularly paying attention or carrying out a special operation.

Furthermore, according to this embodiment, the opening portion 150c in the guide groove 150 is formed so that a groove width thereof becomes wider as heading toward the upstream side of the inserting direction X, making it possible that the protrusion 215 provided in the outer circumferential surface 211 of the toner cartridge 200B easily fits to the opening portion 150c when the toner cartridge 200B is attached to the toner cartridge attaching section 130B.

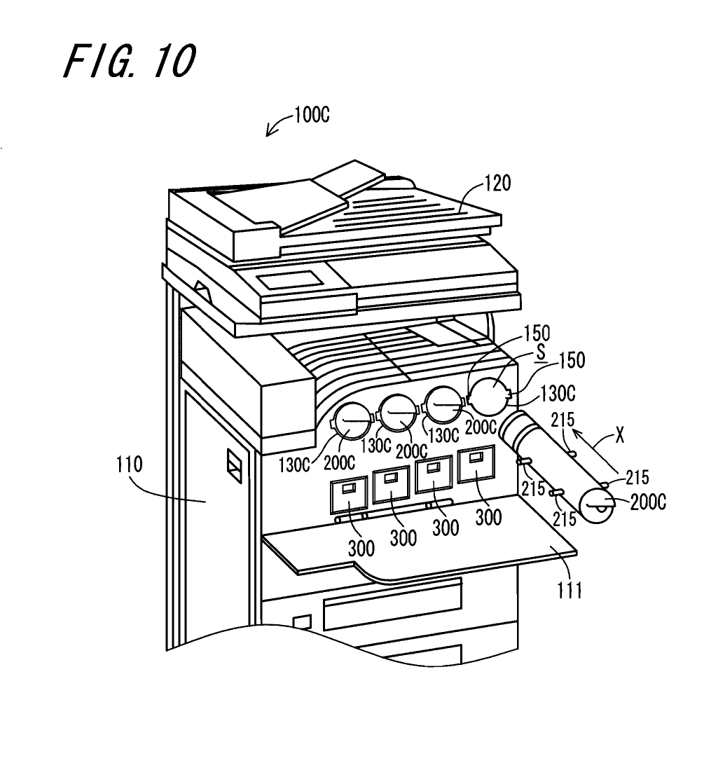

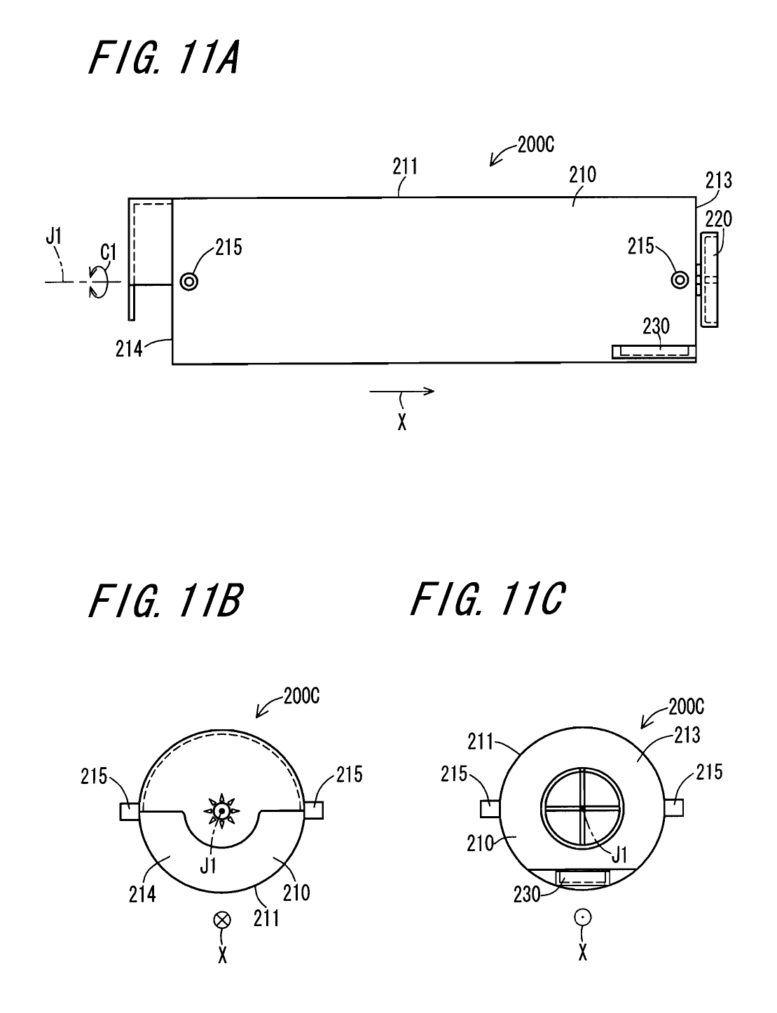

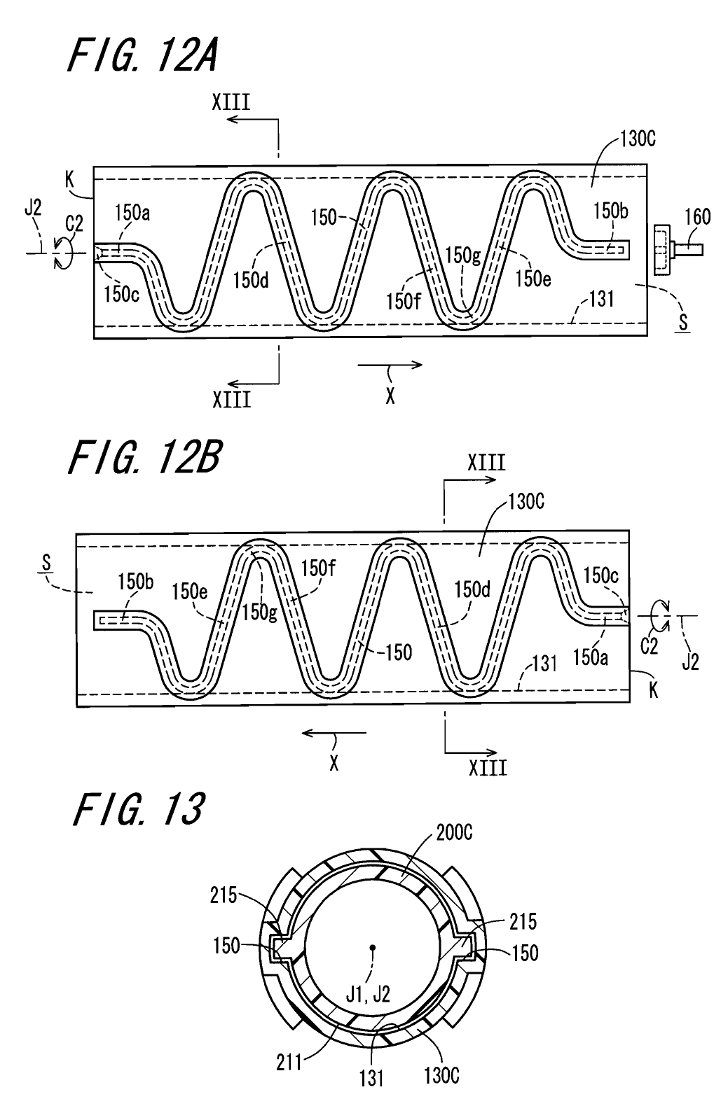

In the second embodiment described above, though one guide groove 150 is engraved in the toner cartridge attaching section 130B, the number of guide grooves engraved in the toner cartridge attaching section may be more than one. Hereinafter, description will be given for this embodiment using FIG. 10, FIGS. 11A through 11C, and FIGS. 12A and 12B.

FIG. 10 is a perspective view showing an external appearance of a multi-functional peripheral 100C according to a third embodiment, and shows a state where an opening/closing door 111 is opened for attaching or replacing a toner cartridge 200C. As to remaining portions excluding the toner cartridge 200C and a toner cartridge attaching section 130C, the multi-functional peripheral 100C according to this embodiment is configured similarly to the multi-functional peripheral 100A according to the first embodiment, so that the same reference numerals are given for the same components and repeated description is omitted.

FIGS. 11A through 11C are views schematically showing a configuration of the toner cartridge 200C, and FIG. 11A is a front view of the toner cartridge 200C, FIG. 11B is a left-side view of the toner cartridge 200C, and FIG. 11C is a right-side view of the toner cartridge 200C. Note that, in the toner cartridge 200C according to this embodiment, for portions configured similarly to the toner cartridge 200B according to the second embodiment, the same reference numerals are given and repeated description is omitted.

In the toner cartridge 200C according to this embodiment, protrusions 215 which protrude toward outside in a radial direction are provided respectively in portions which are in vicinities of end parts of an upstream side and a downstream side of an inserting direction X and which are in a center part of a perpendicular direction when the toner cartridge 200C is attached to the toner cartridge attaching section 130C, in an outer circumferential surface 211 of a toner bottle 210.

FIGS. 12A and 12B are views schematically showing a configuration of the toner cartridge attaching section 130C, and FIG. 12A is a front view of the toner cartridge attaching section 130C and FIG. 12B is a rear view of the toner cartridge attaching section 130C. Note that, in the toner cartridge attaching section 130C according to this embodiment, for portions configured similarly to the toner cartridge attaching section 130B according to the second embodiment, the same reference numerals are given and repeated description is omitted. In addition, in FIG. 12A, a driving shaft 160 which is coupled with a coupling section 220 of the toner cartridge 200C when the toner cartridge 200C is attached to the toner cartridge attaching section 130C is illustrated together.

In the toner cartridge attaching section 130C according to this embodiment, in a right cylindrical inner circumferential surface 131, guide grooves 150 which extend along an attaching section axis direction and zigzags in a circumferential direction C2 around a central axis J2 are engraved on both sides of one side and the other side with respect to a virtual plane which includes the central axis J2 of the toner cartridge attaching section 130C and is parallel to a vertical direction. That is, two guide grooves 150 are engraved in the toner cartridge attaching section 130C.

Then, one of the guide grooves 150 is engraved so as to be rotationally symmetric to the other guide groove 150 with respect to the central axis J2. FIG. 13 is a cross sectional view taken along the line XIII-XIII in FIGS. 12A and 12B, and shows the toner cartridge 200C in a process of insertion into the containing space S together.

As above, even in a case where the number of the guide grooves 150 engraved in the toner cartridge attaching section 130C is more than one, an effect similar to an effect which is able to be attained in the second embodiment is able to be attained.

Note that, in each of the embodiments described above, a middle part in a guide groove is configured with a first linear portion which linearly heads to one side of a circumferential direction as heading to an upstream side of an inserting direction X, a second linear portion which linearly heads to the other side of the circumferential direction as heading to the upstream side of the inserting direction X, and a coupling portion with which the first linear portion and the second linear portion are smoothly coupled while drawing an arc, however, the configuration is not limited thereto and may be made in a rectangular wave shape with a portion which extends in parallel to the circumferential direction and a portion which extends in parallel to an axis direction.

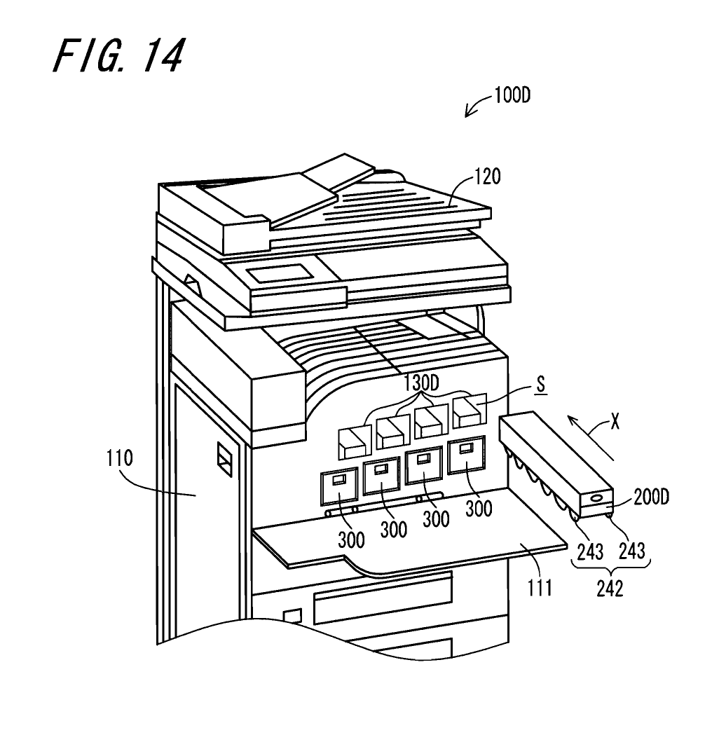

FIG. 14 is a perspective view showing an external appearance of a multi-functional peripheral 100D according to a fourth embodiment, and shows a state where an opening/closing door 111 is opened for attaching or replacing a toner cartridge 200D. As to remaining portions excluding the toner cartridge 200D and a toner cartridge attaching section 130D, the multi-functional peripheral 100D according to this embodiment is configured similarly to the multi-functional peripheral 100A according to the first embodiment, so that the same reference numerals are given for the same components and repeated description is omitted.

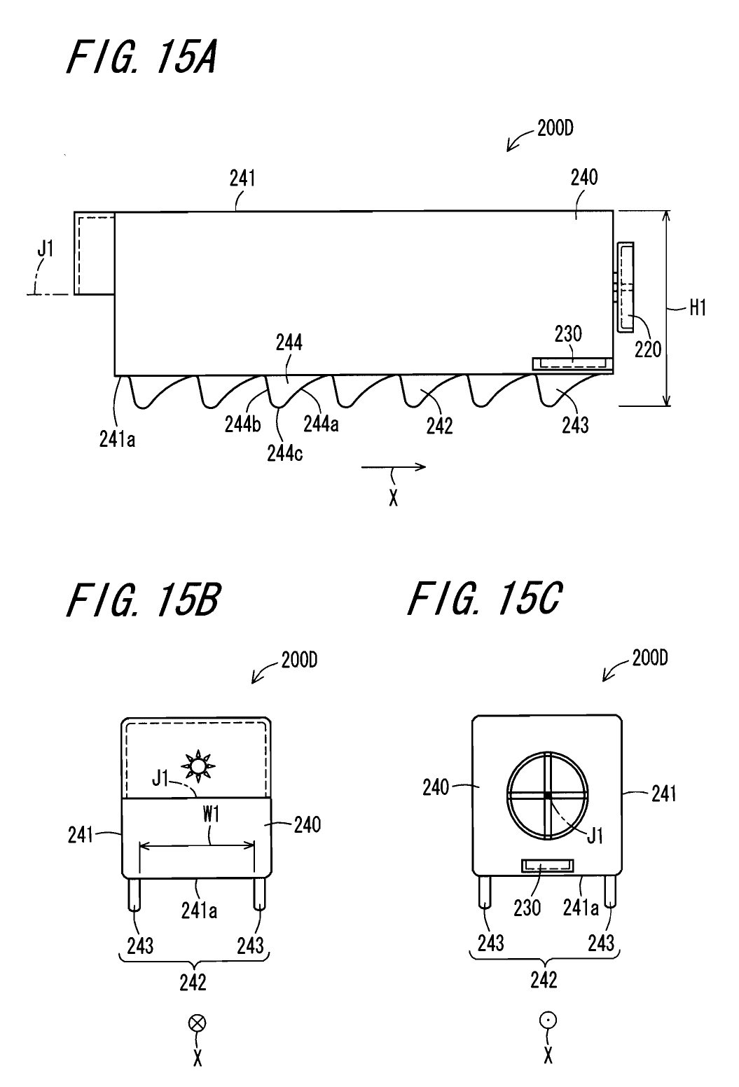

FIGS. 15A through 15C are views schematically showing a configuration of the toner cartridge 200D, and FIG. 15A is a front view of the toner cartridge 200C, FIG. 15B is a left-side view of the toner cartridge 200D, and FIG. 15C is a right-side view of the toner cartridge 200D. Note that, in the toner cartridge 200D according to this embodiment, for portions configured similarly to the toner cartridge 200A according to the first embodiment, the same reference numerals are given and repeated description is omitted.

In this embodiment, the toner cartridge 200D is an angular hollow cylindrical container whose both ends are blocked, and includes a toner bottle 240 having a toner, which is a developer, contained inside and a coupling section 220 which protrudes outside from the toner bottle 240.

In this embodiment, as shown in FIGS. 15A through 15C, a concavo-convex section 242 in which a concave and a convex are formed continuously along a bottle axis direction is provided in an angular cylindrical outer circumferential surface 241 in the toner bottle 240 of the toner cartridge 200D.

In the angular cylindrical outer circumferential surface 241, the concavo-convex section 242 is provided so as to protrude from a bottom part 241a which is a portion constituting a lower end when the toner cartridge 200D is attached to the toner cartridge attaching section 130D, and the concavo-convex section 242 is configured by a pair of concavo-convex rails 243 which extends along the bottle axis direction in this embodiment.

As shown in FIG. 15A, the concavo-convex rail 243 is formed so that concaves and convexes, which are in a serrated shape, continue along the bottle axis direction. When focusing on a unit 244 constituting a concave and a convex in the serrated shape, a first inclined portion 244a which is inclined in a direction separating from the bottom part 241a as heading to an upstream side of an inserting direction X, a second inclined portion 244b which is positioned in the upstream side of the inserting direction X from the first inclined portion 244a and is inclined in a direction approaching to the bottom part 241a as heading to the upstream side of the inserting direction X, and a coupling portion 244c with which the first inclined portion 244a and the second inclined portion 244b are smoothly coupled in a carved manner are included, and the second inclined portion 244b is formed so as to be inclined at a sharper angle than the first inclined portion 244a.

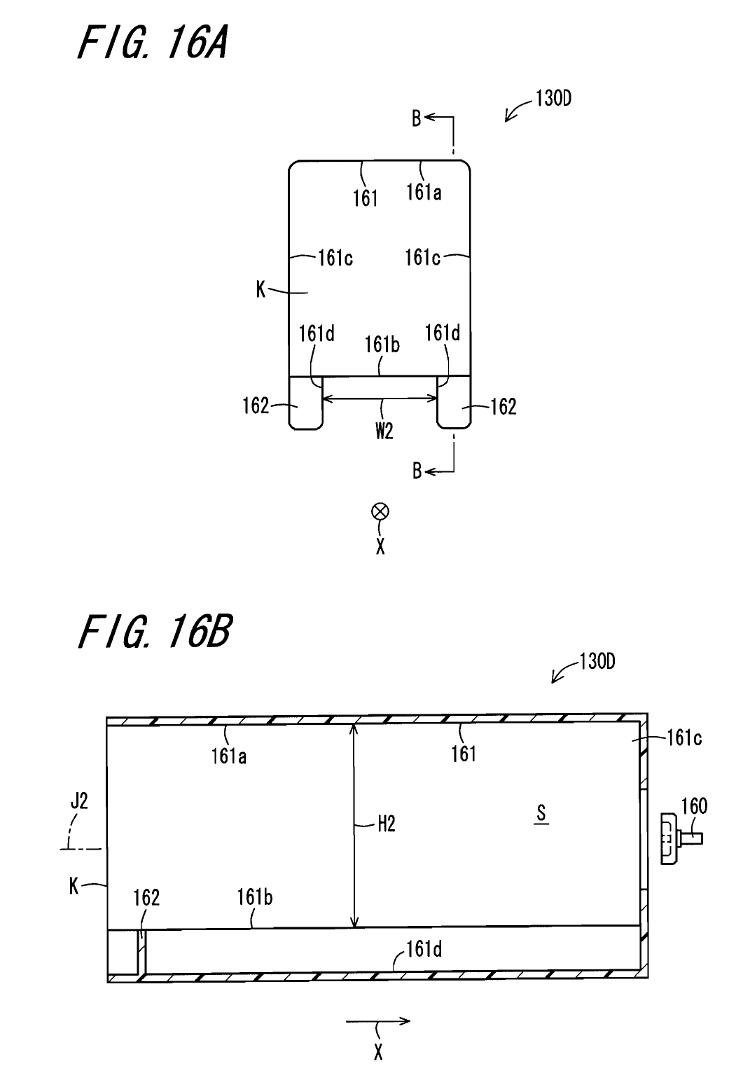

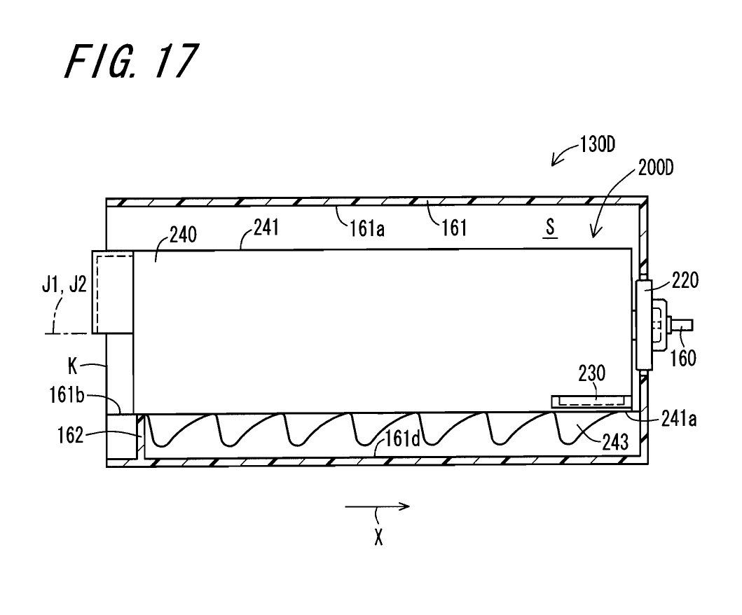

FIGS. 16A and 16B are views schematically showing a configuration of the toner cartridge attaching section 130D, and FIG. 16A is a front view of the toner cartridge attaching section 130D and FIG. 16B is a cross sectional view taken along the line B-B in FIG. 16A. FIG. 17 is a cross sectional view showing a state where the toner cartridge 200D is attached to the toner cartridge attaching section 130D. Note that, in the toner cartridge attaching section 130D according to this embodiment, for portions configured similarly to the toner cartridge attaching section 130A according to the first embodiment, the same reference numerals are given and repeated description is omitted.

The toner cartridge attaching section 130D is a portion to which the toner cartridge 200D is attached in the apparatus main body 110, and defines the containing space S in which the toner cartridge 200D is contained in an attached state and the insertion opening K which leads to the containing space S for inserting the toner cartridge 200D into the containing space S. The toner cartridge attaching section 130D is configured by including an angular cylindrical inner circumferential surface 161 which is larger than the outer circumferential surface 241 of the toner bottle 240.

The inner circumferential surface 161 includes an upper wall part 161a and a bottom wall part 161b which are provided so as to be perpendicular with respect to the vertical direction and side wall parts 161c which are provided so as to be parallel to the vertical direction, and formed so that a distance H2 between the upper wall part 161a and the bottom wall part 161b is larger than a height dimension H1 of the toner cartridge 200D (refer to FIG. 15A).

As sown in FIG. 17, the bottom wall part 161b is a portion on which the bottom part 241a of the toner bottle 240 is placed when the toner cartridge 200D is attached to the toner cartridge attaching section 130D, that is, a portion which is in surface contact with the bottom part 241a of the toner bottle 240, and a grooved part 161d to which each of the concavo-convex rails 243 provided so as to protrude in the bottom part 241a of the toner bottle 240 fits when the toner cartridge 200D is attached to the toner cartridge attaching section 130D is formed respectively on both sides of the bottom wall part 161b when viewed in an attaching section axis direction.

These two grooved parts 161d are provided so that a distance W2 therebetween is smaller than a distance W1 between the pair of the concavo-convex rails 243 in the toner cartridge 200D (refer to FIG. 15B).

Moreover, in each grooved part 161d, a kick-up rib 162 is provided at a position in a vicinity of the insertion opening K. The kick-up rib 162 is a protrusion which protrudes upward from a bottom part of the grooved part 161d and formed so that an upper end part thereof is flush with the bottom wall part 161b.

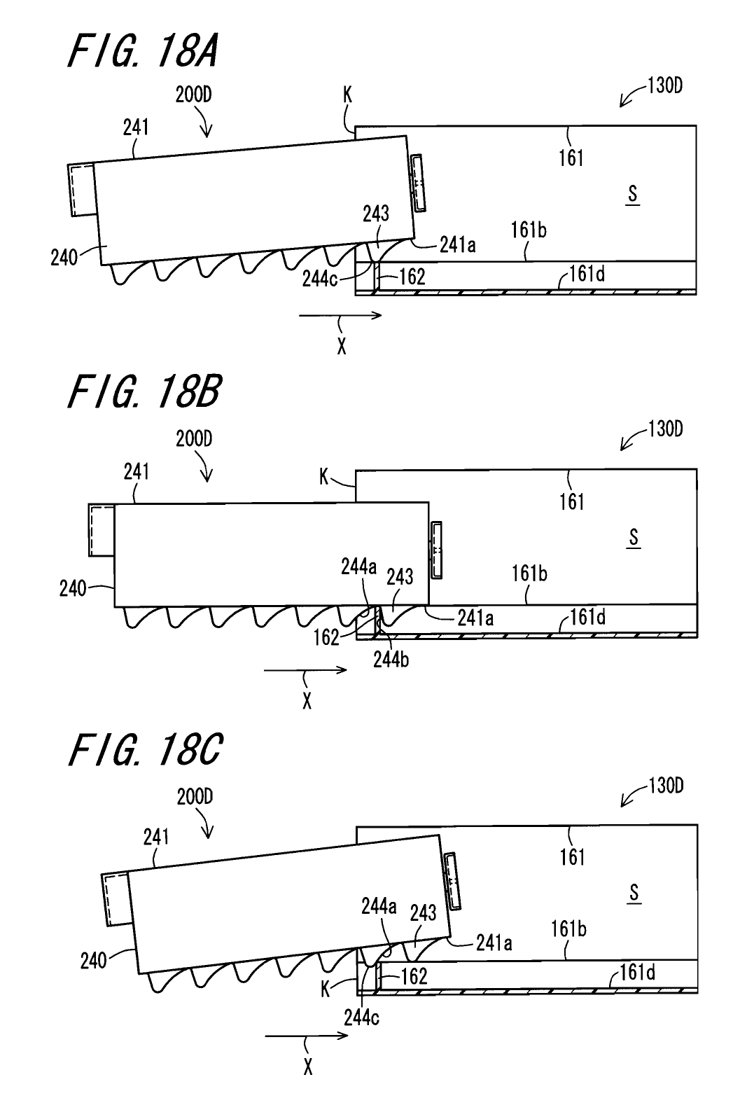

FIGS. 18A through 18C are views for explaining a process that the toner cartridge 200D is inserted into the containing space S of the toner cartridge attaching section 130D. In the multi-functional peripheral 100D according to this embodiment, with the configuration described above, when the toner cartridge 200D is inserted into the containing space S of the toner cartridge attaching section 130D, the insertion is to be performed such that the upper end part of the kick-up rib 162 provided in the grooved part 161d traces a lower surface of the concavo-convex rail 243 provided so as to protrude in the bottom part 241a of the toner bottle 240.

That is, when the toner cartridge 200D is inserted more in the inserting direction X from a state where the upper end part of the kick-up rib 162 is in contact with a lower surface of the coupling portion 244c in the concavo-convex rail 243, the upper end part of the kick-up rib 162 fits between the second inclined portion 244b and the first inclined portion 244a as shown in FIG. 18B.

In this process, the toner cartridge 200D falls downward by a height of the concavo-convex rail 243 (a distance between the bottom part 241a of the toner bottle 240 and the coupling portion 244c) and collides with the upper end part of the kick-up rib 162, resulting in that an impact is applied.

Then, when the toner cartridge 200D is inserted more in the inserting direction X from a state where the upper end part of the kick-up rib 162 fits between the second inclined portion 244b and the first inclined portion 244a, the upper end part of the kick-up rib 162 is guided to a lower surface of the first inclined portion 244a to be in contact with a lower surface of the next coupling portion 244c as shown in FIG. 18C.

As above, according to this embodiment, when the toner cartridge 200D is attached to the toner cartridge attaching section 130D, the toner cartridge 200D is to be inserted into the containing space S while being applied with a continuous impact by the kick-up rib 162.

Accordingly, even in a case where a toner is contained in a compressed state inside the toner bottle 240, due to the impact applied by the kick-up rib 162, the toner in the compressed state is disintegrated, making it possible to ease the compressed state. In this manner, in this embodiment, force applied by a user in order to insert the toner cartridge 200D into the containing space S is able to be converted to force for disintegrating the toner.

This makes it possible to prevent applying large load to the conveying screw provided inside the toner bottle 240, and thus to prevent a motor for rotationally driving the conveying screw from losing synchronism or being broken.

Moreover, according to this embodiment, every time when the toner cartridge 200D is attached to the toner cartridge attaching section 130D, the toner cartridge 200D is to be applied an impact by the kick-up rib 162, so that the user is able to ease the compressed state of the toner in the toner bottle 240 without particularly paying attention or carrying out a special operation.

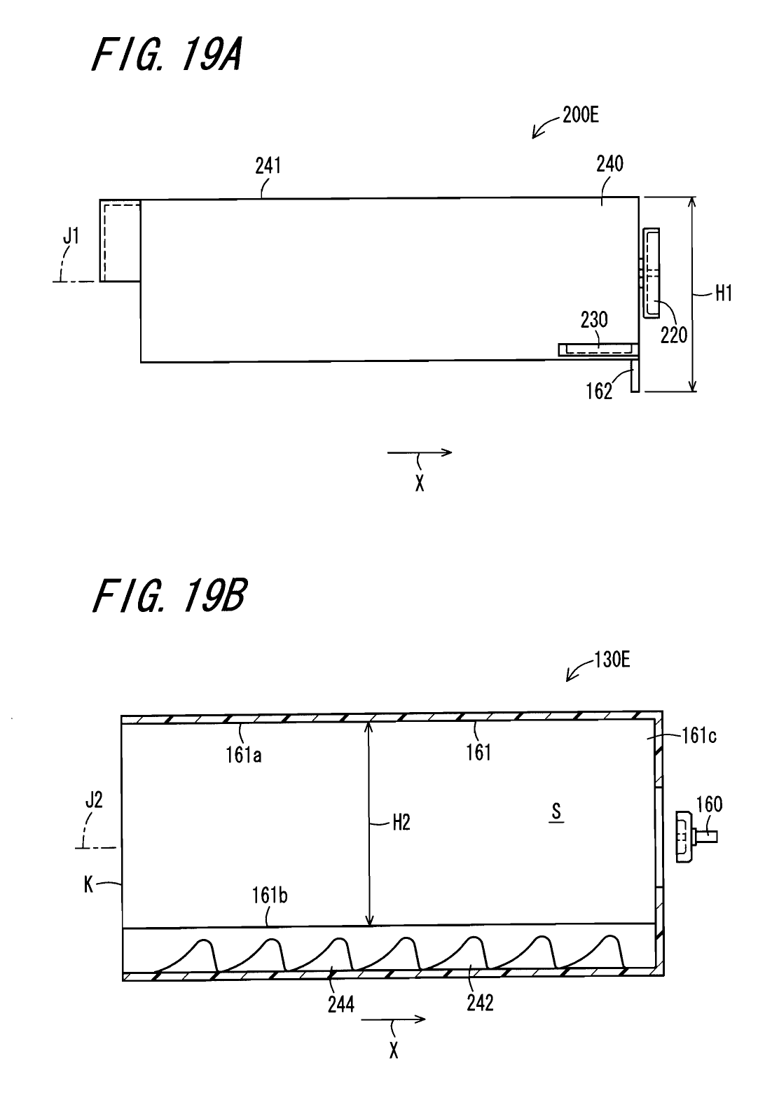

In the fourth embodiment described above, though the concavo-convex section 242 is provided in the toner cartridge 200D and the kick-up rib 162 is formed in the toner cartridge attaching section 130D, on the contrary, as shown in FIG. 19A and FIG. 19B, a concavo-convex section 242 may be provided in a toner cartridge attaching section 130E and a kick-up rib 162 may be formed in a toner cartridge 200E.

Moreover, in the fourth embodiment, two grooved parts 161d are formed in both sides of the bottom wall part 161b in the toner cartridge attaching section 130D and the pair of the concavo-convex rails 243 are correspondingly provided so as to protrude in the bottom part 241a of the toner bottle 240 in the toner cartridge 200D, however, not being limited thereto, a configuration may be made so that one grooved part is formed in a center of a bottom wall part in a toner cartridge attaching section and one concavo-convex rail is correspondingly provided so as to protrude in a bottom part of a toner bottle in a toner cartridge.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. An image forming apparatus, comprising:
a toner cartridge which contains a toner; and
an image forming apparatus main body which has a toner cartridge attaching section for attaching the toner cartridge thereto, the toner cartridge attaching section defining a containing space in which the toner cartridge is contained in an attached state and an insertion opening which leads to the containing space for inserting the toner cartridge into the containing space therethrough, the image forming apparatus main body forming an image in accordance with image data on a recording medium using toner supplied from the toner cartridge attached to the toner cartridge attaching section,
the toner cartridge having a tubular outer circumferential surface extending along an inserting direction for insertion of the toner cartridge into the containing space through the insertion opening,
the toner cartridge attaching section having a tubular inner circumferential surface which faces the tubular outer circumferential surface of the toner cartridge in the attached state of the toner cartridge,
in one of the tubular outer circumferential surface of the toner cartridge and the tubular inner circumferential surface of the toner cartridge attaching section, a guide groove being engraved that extends along an axis direction thereof and zigzags along a circumferential direction thereof, and
in the other of the tubular outer circumferential surface of the toner cartridge and the tubular inner circumferential surface of the toner cartridge attaching section, a protrusion being provided that fits in the guide groove for insertion of the toner cartridge into the containing space through the insertion opening.

2. An image forming apparatus, comprising:
a toner cartridge which contains a toner; and
an image forming apparatus main body which has a toner cartridge attaching section for attaching the toner cartridge thereto, the toner cartridge attaching section defining a containing space in which the toner cartridge is contained in an attached state and an insertion opening which leads to the containing space for inserting the toner cartridge into the containing space therethrough, the image forming apparatus main body forming an image in accordance with image data on a recording medium using toner supplied from the toner cartridge attached to the toner cartridge attaching section,
the toner cartridge having a tubular outer circumferential surface extending along an inserting direction for insertion of the toner cartridge into the containing space through the insertion opening,
the toner cartridge attaching section having a tubular inner circumferential surface which faces the tubular outer circumferential surface of the toner cartridge in the attached state of the toner cartridge,
in one of the tubular outer circumferential surface of the toner cartridge and the tubular inner circumferential surface of the toner cartridge attaching section, a concavo-convex section being provided in which a concave and a convex are formed continuously along an axis direction thereof, and
in the other of the tubular outer circumferential surface of the toner cartridge and the tubular inner circumferential surface of the toner cartridge attaching section, a protrusion being provided that faces the concavo-convex section for insertion of the toner cartridge into the containing space through the insertion opening.

3. A toner cartridge capable of being attached to a toner cartridge attaching section provided in an image forming apparatus main body which forms an image in accordance with image data on a recording medium using a toner, comprising:
a tubular outer circumferential surface extending along an inserting direction for insertion of the toner cartridge into a containing space formed in the toner cartridge attaching section, the tubular outer circumferential surface having a guide groove engraved therein in which a protrusion provided in an inner circumferential surface defining the containing space in the toner cartridge attaching section fits for insertion of the toner cartridge into the containing space, the guide groove extending along an axis direction thereof and zigzagging along a circumferential direction thereof.

4. A toner cartridge capable of being attached to a toner cartridge attaching section provided in an image forming apparatus main body which forms an image in accordance with image data on a recording medium using a toner, comprising:
a tubular outer circumferential surface extending along an inserting direction for insertion of the toner cartridge into a containing space formed in the toner cartridge attaching section, the tubular outer circumferential surface being provided with a protrusion which fits in a guide groove engraved in an inner circumferential surface defining the containing space in the toner cartridge attaching section for insertion of the toner cartridge into the containing space, the guide groove extending along an axis direction thereof and zigzagging along a circumferential direction thereof.

5. A toner cartridge capable of being attached to a toner cartridge attaching section provided in an image forming apparatus main body which forms an image in accordance with image data on a recording medium using a toner, comprising:
a tubular outer circumferential surface extending along an inserting direction for insertion of the toner cartridge into a containing space formed in the toner cartridge attaching section, the tubular outer circumferential surface being provided with a concavo-convex section in which a concave and a convex are formed continuously along an axis direction thereof, the concavo-convex section facing a protrusion provided in an inner circumferential surface defining the containing space in the toner cartridge attaching section for insertion of the toner cartridge into the containing space.

6. A toner cartridge capable of being attached to a toner cartridge attaching section provided in an image forming apparatus main body which forms an image in accordance with image data on a recording medium using a toner, comprising:
a tubular outer circumferential surface extending along an inserting direction for insertion of the toner cartridge into a containing space formed in the toner cartridge attaching section, the tubular outer circumferential surface being provided with a protrusion which faces a concavo-convex section provided in an inner circumferential surface defining the containing space in the toner cartridge attaching section for insertion of the toner cartridge into the containing space, the concavo-convex section having a concave and a convex formed continuously along an axis direction thereof.
